(19) United States
(12) Patent Application Publication
(10) Pub. No.: US 2007/0143447 A1
(43) Pub. Date: Jun. 21, 2007

(54) Methods and systems for providing a structured application

(76) Inventors: Paige A. Beckum, Berkeley Lake, GA (US); Andrew L. Kilinski, Suwanee, GA (US)

Correspondence Address: MERCHANT & GOULD BELLSOUTH CORPORATION, P.O. BOX 2903, MINNEAPOLIS, MN, 55402, US

(21) Appl. No.: 11/496,977

(22) Filed: Aug. 1, 2006

Related U.S. Application Data
(63) Continuation of application No. 11/314,936, filed on Dec. 21, 2005.

(51) Int. Cl. G06F 15/16

(52) U.S. Cl. 709/219

(57) ABSTRACT

Systems and methods provide a structured application. The systems and methods may include calling an application service in response to a received request and receiving first data through the application service. Furthermore, the systems and methods may include calling an enterprise service from the application service in response to the received first data. The enterprise service may be configured to retrieve second data from a back-end system. Moreover, the systems and methods may include transmitting the second data from the enterprise service to the application service and providing a user with the second data.

### RELATED APPLICATION

The present application is a continuation of U.S. application Ser. No. 11/314,936, filed on Dec. 21, 2005, and entitled METHODS AND SYSTEM FOR PROVIDING A STRUCTURED APPLICATION.

### BACKGROUND OF THE INVENTION

I. Field of the Invention

The present invention generally relates to methods and systems for providing a structured application. More particularly, the present invention relates to providing a structured application using, for example, reusable components.

II. Background Information

Enterprises need a consistent way of building applications within the enterprises' computing spaces. In some situations, applications need to interface with users and legacy systems. For example, a delivery team within an enterprise may go off and develop an application in one way and another team may develop their application in another way. Specifically, each team may spend time building different interfaces to users and legacy systems. Using the conventional approach, each team spends time and effort building a model to work production wise that will interface with users and legacy systems. Thus, the conventional strategy is to create application interfaces for users and for legacy systems each time an application is created. This often causes problems because the conventional strategy does not provide a consistent way of building applications within an enterprise's computing space.

In view of the foregoing, there is a need for methods and systems for providing a structured application more optimally. Furthermore, there is a need for providing a structured application using, for example, reusable components.

### SUMMARY OF THE INVENTION

Consistent with embodiments of the present invention, systems and methods are disclosed for providing a structured application.

In accordance with one embodiment, a method for providing a structured application comprises calling an application service in response to a received request, receiving first data through the application service, and calling an enterprise service from the application service in response to the received first data, the enterprise service configured to retrieve second data from a back-end system.

According to another embodiment, a system for providing a structured application comprises a memory storage for maintaining a database and a processing unit coupled to the memory storage, wherein the processing unit is operative to call an application service in response to a received request, receive first data through the application service, and call an enterprise service from the application service in response to the received first data, the enterprise service configured to retrieve second data from a back-end system.

In accordance with yet another embodiment, a computer-readable medium which stores a set of instructions which when executed performs a method for providing a structured application, the method executed by the set of instructions comprising calling an application service in response to a received request, receiving first data through the application service, and calling an enterprise service from the application service in response to the received first data, the enterprise service configured to retrieve second data from a back-end system.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary structured application framework consistent with an embodiment of the present invention;

FIG. 2 is a block diagram of an exemplary structured application system consistent with an embodiment of the present invention;

FIG. 3 is a block diagram of an exemplary services processor consistent with an embodiment of the present invention; and

FIG. 4 is a flow chart of an exemplary method for providing a structured application consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention provide a structured application. A structured application framework includes components that enable an enterprise to build applications and services to support the applications. The applications may comprise, but are not limited to, online web-based or web-supported applications. The services that support the applications can be called by the application to access back-end or legacy type systems. Accordingly, the services may comprise enabling middleware. Consequently, consistent with embodiments of the present invention, an architecture is provided that allows an enterprise to create services in a consistent way so that an online application, for example, is able to use the created services. Furthermore, embodiments of the present invention enable more rapid development of any applications or services within the enterprise.

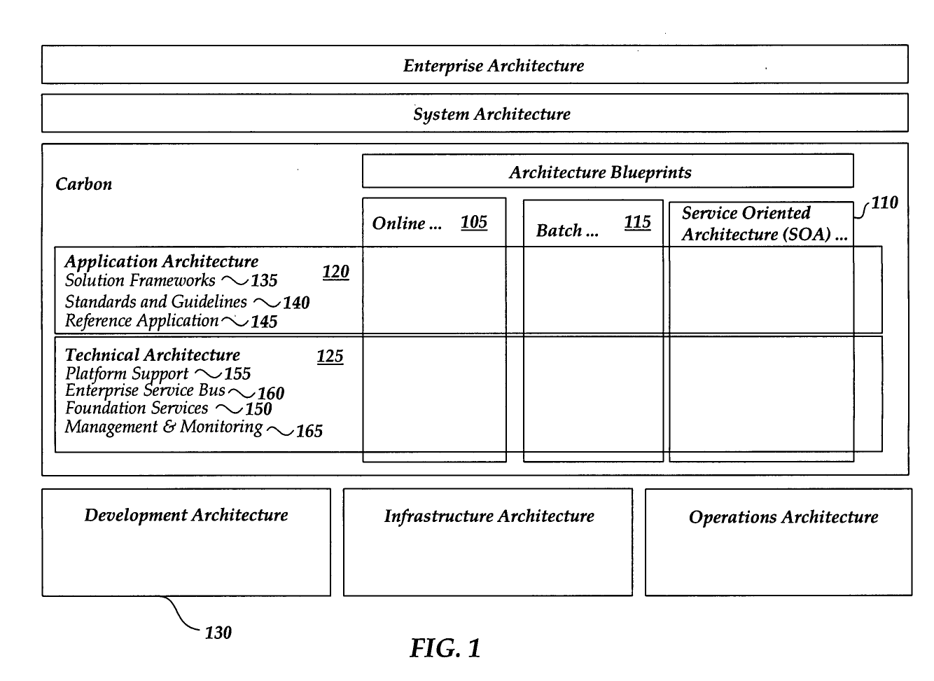

FIG. 1 is a block diagram of an exemplary structured application framework 100 consistent with an embodiment of the present invention. Framework 100 provides structured application frameworks and reusable components to guide developers in ways to build various types of applications. These applications may comprise, for example, an online/web 105, a service oriented architecture (SOA) 110, and batch 115. Given diversity in platform standards, vendor offerings, and client preference, embodiments of the invention establish consistent frameworks. Accordingly, development teams may conceptualize and deliver technical and application architectures for an engagement. Moreover, embodiments of the invention provide the architecture knowledge capital and assets to support successful project delivery.

FIG. 1 describes high level components and services necessary to build, test, and run an application in an execution environment. For example, structured application framework 100 provides prescription in an application architecture 120 and a technical architecture 125. A development architecture 130 is used to establish a single holistic view of tools, process, and standards needed to develop an application. All information may be provided through a development portal (not shown.)

Application architecture 120 is the set of standards and patterns that describe to designers and developers how to design and build applications in a common way using underlying technical architecture 125. Application architecture 120 includes a solution frameworks 135, a standards and guidelines 140, and reference applications 145.

Solution frameworks 135 define the assets specific to a technology or platform. Solution frameworks 135 are divided up between the styles of architecture blueprint. There are separate solution frameworks 135 for presentation, SOA (e.g. request/reply and long-running transactions), integration, and security. Requirements for solution frameworks 135 are driven, for example, by architecture blueprints. Solution frameworks 135 leverage foundation services for an appropriate platform.

Standards and guidelines 140 define the practices that should be followed when creating reusable enterprise services and applications. Standards within standards and guidelines 140 are defined to keep a consistent look and feel across assets being developed by different teams throughout the enterprise. Guidelines within standards and guidelines 140 provide developers with cookbooks and usage guides on how to use structured application framework 100.

For each architecture blueprint defined by structured application framework 100, an associated reference application 145 will be created. Reference application 145 provides an implementation that can be reviewed for insight into how structured application framework 100 is used to implement a particular blueprint and details on how a standard in standards and guidelines 140 is to be followed.

Technical architecture 125 is composed of platform capabilities and custom architecture frameworks. Technical architecture 125 provides a standard environment in which to build and deploy applications and reduces the complexity of application development through the use of abstraction. Technical architecture 125 comprises foundation services 150, a platform support 155, an enterprise service bus (ESB) 160, and management and monitoring 165.

Platform support 155 provides the fundamental technology to build architecture and applications. Both J2EE and .NET platforms are widely used by many enterprises. Structured application framework 100 provides architecture capabilities built on both platforms. A design goal for structured application framework 100 is to provide similar application program interfaces (APIs) and shared services where possible. Platform support 155 includes the technologies and software to build, deploy, and test applications.

ESB 160 is a shared messaging layer for connecting applications and other services throughout an enterprise computing infrastructure. ESB 160 supplements its core asynchronous messaging backbone with: i) intelligent transformation and routing; ii) a service broker which provides capability for services to be invoked using various message exchange patterns, quality of service, and transports; and iii) an interoperability standard. Technical architecture 125 may reduce point to point integration of services and may promote a loosely coupled interaction between consumers and providers and may allow management and monitoring 165 to be handled by system 100. Management and monitoring 165 may provide for the monitoring and management of events within system 100 and outside system 100.

Foundation services 150 provide common services recognized in software development and new services fundamental to SOA. Common services include logging, configuration, error management, and persistence. The concept of a service access framework and message transformations provide functionality supporting a SOA. Foundation services 150 are leveraged when building services and presentation tiers.

Development architecture 130 is a unified collection of technology services, tools, techniques, and standards for constructing and maintaining application software. The development environment is used to build the technical and application architectures as well as functional applications. Development architecture 130 comprises: i) a development process; ii) a developer portal; iii) tools and utilities; and iv) a service registry.

The development process defines the software development lifecycle from design phase to production deployment. It is used in conjunction with other known development processes such as Rational Unified Process. The development process may comprise best practices for different phases of the software development lifecycle. In addition, tools and frameworks associated with various development phases have also been associated with the development process.

The developer portal is a single point of reference where any application developer can obtain information about developing reusable enterprise services. A developer can create a reusable enterprise service from scratch by following the portal's flow-like layout, regardless of platform technology and application architecture.

The tools and utilities are a set of tools to help facilitate the code development process. The utilities help test application team's services, query logging resources for debugging purposes, and manage domain configuration files.

The service registry represents a directory system that correlates a specific service to their respective owners and request/response schemas. The service registry contains search capabilities to permit new application developers to search through a large list of available services.

An embodiment consistent with the invention comprises a system for providing a structured application. The system comprises a memory storage for maintaining a database and a processing unit coupled to the memory storage. The processing unit is operative to call an application service in response to a received request and receive first data through the application service. Furthermore, the processing unit is operative to call an enterprise service from the application service in response to the received first data. The enterprise service is configured to retrieve second data from a back-end system.

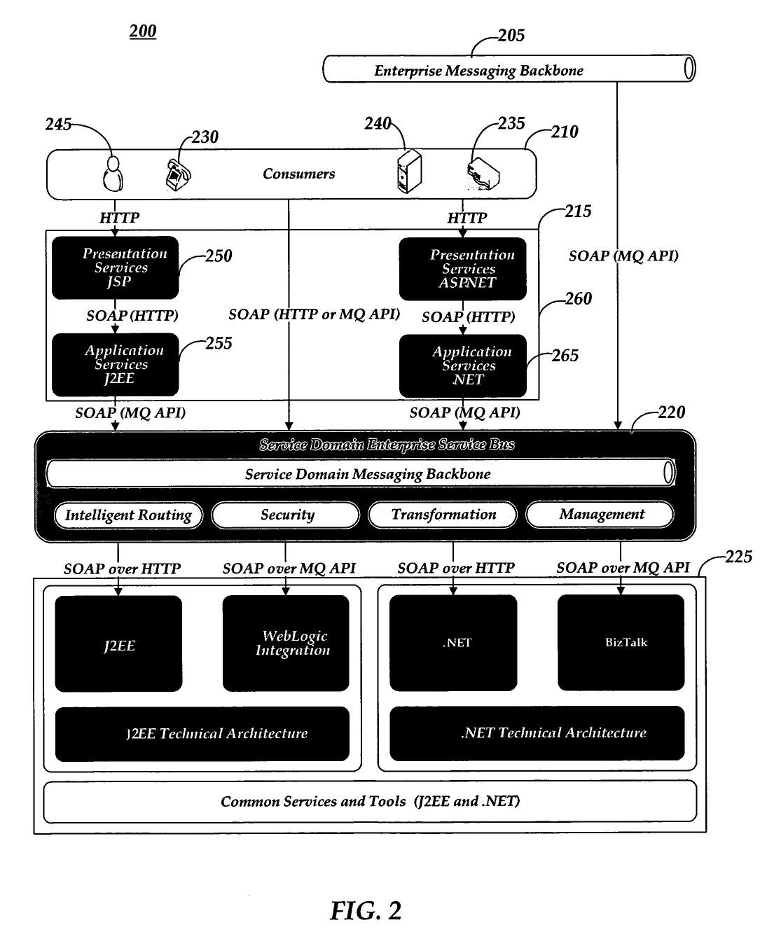

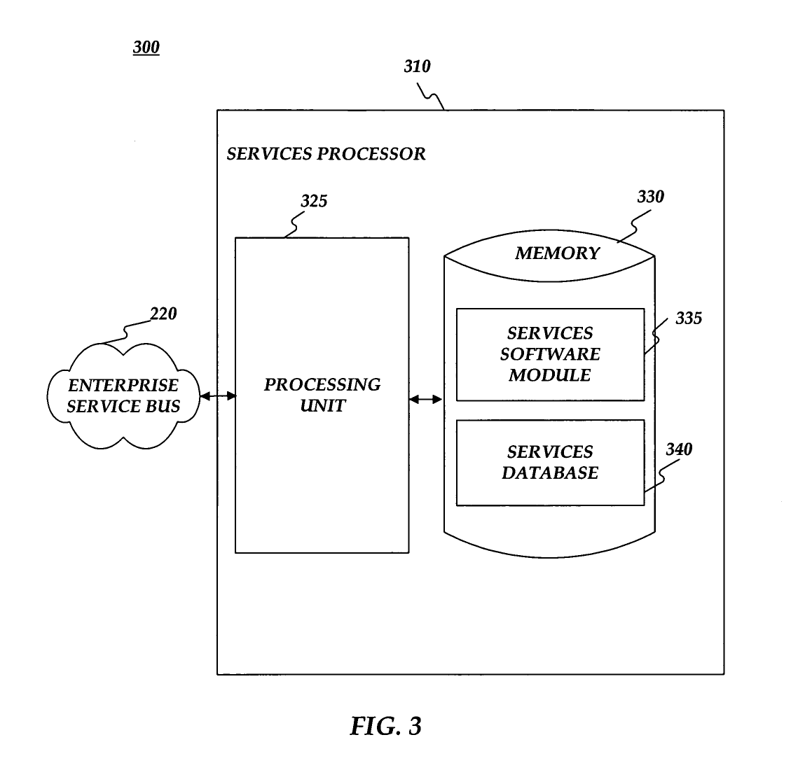

Consistent with an embodiment of the present invention, the aforementioned memory, processing unit, and other components are implemented in a structured application system, such as an exemplary structured application system 200 of FIG. 2. Any suitable combination of hardware, software, and/or firmware may be used to implement the memory, processing unit, or other components. By way of example, the memory, processing unit, or other components may be implemented within a services processor 310 as described below with respect to FIG. 3, in combination with system 200. For example, presentation and application services 215 and enterprise services 225 may be implemented in services processor 310. Alternately, presentation and application services 215 and enterprise services 225 may each be implemented in separate processors. The aforementioned system and processors are exemplary and other systems and processors may comprise the aforementioned memory, processing unit, or other components, consistent with embodiments of the present invention.

By way of a non-limiting example, FIG. 2 illustrates system 200 in which the features and principles of the present invention may be implemented. As illustrated in the block diagram of FIG. 2, system 200 includes an enterprise messaging backbone 205, service consumers 210, presentation and application services 215, enterprise service bus 220, and enterprise services 225.

Enterprise messaging backbone 205 allows servicing domains to communicate across a highly distributed asynchronous environment. For example, a reusable enterprise service can leverage this enterprise fabric when calling a customer account service implemented in another servicing domain. The location and technology are abstracted from the consumer and handled by the enterprise infrastructure.

Service consumers 210 comprise a wide range of consumers including, for example, IVR systems 230, a web client 235, call center desktops 240, and business to business (B2B) gateways 245 that expose services to enterprise partners. The use of standards and support for multiple ways of invoking services (simple object access protocol (SOAP) over HTTP, SOAP over JMS, SOAP over message queue (MQ) API, etc.) ensures that each type of consumer can leverage reusable enterprise services. For example, consumers 210 may represent consumer front-end applications. Front-end users of system 200 may comprise, for example, call center service representatives, consumes on the Internet, or vendors that have different applications that need to interface with the enterprise's systems. SOAP is a message-based protocol based on XML for accessing services on the internet. MQ is a messaging middleware that allows programs to communicate with each other across various diverse platforms.

Presentation and application services 215 are specific to an application development team. Presentation and application services 215 comprise a presentation services JSP 250 and an application services J2EE 255 corresponding to a first platform and a presentation services ASP.NET 260 and application services .NET 265 corresponding to a second platform. The first platform may comprise, for example, Java, J2EE environments. The second platform may comprise, for example, Microsoft.net tools. Both platforms may be used by the enterprise.

Presentation services JSP 250 and presentation services ASP.NET 260 comprise user interfaces (or the user front-end) for service consumers 210. Application services J2EE 255 and application services .NET 265 are application services that support presentation services JSP 250 and presentation services ASP.NET 260 front end applications. Application services J2EE 255 and application services .NET 265 meet the business logic at the application level. Application services 215 are services comprising callable application segments. They can be called via an application program interface (API). For example, rather than having a user interface for a person that is sitting in front of a screen, an external system corresponding to the user front-end application can call a service to provide the application functionality necessary to support the user experience.

Enterprise service bus 220, for service domains, provides intelligent routing, security, transformation, brokering, and monitoring and management. Enterprise service bus 220 is a middleware infrastructure that allows messaging between high level application services and lower level tiers for access to back-end interlacing systems (e.g. legacy systems).

The architecture allows enterprise services 225 to be implemented in any product or technology. One requirement is that enterprise services 225 adhere to an interoperability standard (SOAP+header elements). Enterprise services 225 comprise common services that are on an enterprise level and are general to the enterprise rather than the higher level services (presentation and application services 215) that are more specific to the application. Enterprise services 225 may be built using the same technology (e.g. the same framework and the same components) used to built the higher level services (i.e. application services 215). Enterprise services 225, however, have a scope that is different than application services 215.

For example, a service within enterprise services 225 may be called to reach a banking application. The enterprise may have a service order. In order to process the service order, the enterprise may need to go to a back-end or legacy system that masters all of the information needed for the service order. If the service order needs other information, there may be a service within enterprise services 225 that accesses a legacy or back-end system that houses all enterprise product and pricing information. Via enterprise service bus 220, a message may be sent from one of application services 215 to a lower level service (enterprise services 225) that has direct access with the appropriate legacy or back-end system.

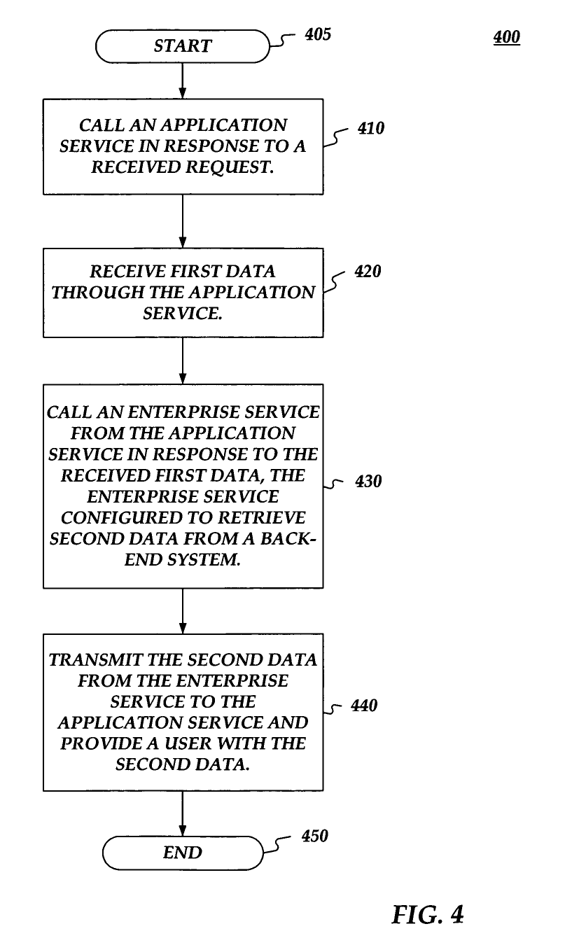

FIG. 3 shows services processor 310, as referenced above, in more detail. As shown in FIG. 3, services processor 310 may include a processing unit 325 and a memory 330. Memory 330 may include a services software module 335 and a services database 340. While executing on processing unit 325, services software module 335 may perform processes for providing a structured application, including, for example, one or more of the stages of method 400 described below with respect to FIG. 4. For example, presentation and application services 215 and enterprise services 225 may be provided by services processor 310. Furthermore, any combination of software module 335 and database 340 may be executed on or reside in services processor 310 or some stages of method 400 may be executed on another processor. For example, presentation and application services 215 and enterprise services 225 may each be provided by different processors.

Services processor 310 (“the processor”) may be implemented using a personal computer, network computer, mainframe, or other similar microcomputer-based workstation. The processor may though comprise any type of computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Service consumers 210 may communicate with services processor 310 over a network. The network may comprise, for example, a local area network (LAN) or a wide area network (WAN). Such networking environments are commonplace in offices, enterprise-wide computer networks, intranets, and the Internet. When a LAN is used as the network, a network interface located at any of processor 310 and service consumers 210 may be used to interconnect processor 310 and service consumers 210. When the network is implemented in a WAN networking environment, such as the Internet, the processors may typically include an internal or external modem (not shown) or other means for establishing communications over the WAN. Further, in utilizing the network, data sent over the network may be encrypted to insure data security by using known encryption/decryption techniques.

In addition to utilizing a wire line communications system as the network, a wireless communications system, or a combination of wire line and wireless may be utilized as the network in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processor in the wireless environment can be any mobile terminal, such as the mobile terminals described above. Wireless data may include, but is not limited to, paging, text messaging, e-mail, Internet access and other specialized data applications specifically excluding or including voice transmission. For example, the processor may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

FIG. 4 is a flow chart setting forth the general stages involved in an exemplary method 400 consistent with the invention for providing a structured application using system 200 of FIG. 2 and processor 310 of FIG. 3. Exemplary ways to implement the stages of exemplary method 400 will be described in greater detail below. As a general example, an enterprise (e.g. a broadband service provider) may have an external vendor that needs a limited product set. Accordingly, the service provider may create an application service to filter or do specific other functions necessary to expose products or services that the vendor needs. That application service will call an enterprise service, for example, to provide product information from a back-end system.

Exemplary method 400 begins at starting block 405 and proceeds to stage 410 where services processor 310 calls an application service in response to a received request. For example, the vendor may be a broadband reseller for broadband service provided by the service provider. The vendor may be a large retailer (e.g. a consumer electronic stores) that wishes to sell the service provider's broadband service. Consequently, the vendor (e.g. one of service consumers 210) may need information from the service provider, may log into system 200 and send the request.

From stage 410, where services processor 310 calls the application service in response to the received request, exemplary method 400 advances to stage 420 where services processor 310 receives first data through the application service. For example, the vendor communicates with system 200 through a presentation service. Through the presentation service, the vendor calls an application service, for example, that may provide specific products (e.g. DSL service) that the vendor could sell. The application service may have some logic specific to the vendor in terms of limiting products or embellishing new product data.

Once services processor 310 receives the first data through the application service in stage 420, exemplary method 400 continues to stage 430 where services processor 310 calls an enterprise service from the application service in response to the received first data. The enterprise service is configured to retrieve second data from a back-end system. For example, the application service, through enterprise service bus 220, calls the enterprise service (e.g. a general product service) that, in turn, calls the back-end product database in the back-end system (e.g legacy system). The back-end product database, for example, has information for all products in which the vendor is interested. The enterprise service, for example, may provide the second data corresponding to DSL products or give a general listing of products available on the back-end system. Consequently, the application service adds business logic (e.g. embellish or filter data) to the second data retrieved from the enterprise service. The enterprise service, for example, is more generic in nature and may provide general product and placement information.

After services processor 310 calls the enterprise service from the application service in stage 430, exemplary method 400 proceeds to stage 440 where services processor 310 transmits the second data from the enterprise service to the application service and provides a user (i.e. the vendor) with the second data. For example, system 200 returns the second data corresponding to DSL products to the vendor in response to the request. After services processor 310 transmits the second data from the enterprise service to the application service and provides the user with the second data in stage 440, exemplary method 400 then ends at stage 450.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing a structured application, the method comprising:
calling an application service in response to a received request;
receiving first data through the application service; and
calling an enterprise service from the application service in response to the received first data, the enterprise service configured to retrieve second data from a back-end system.

2. The method of claim 1, wherein calling the application service comprises calling the application service comprising a presentation service configured to provide a user interface.

3. The method of claim 1, wherein calling the application service comprises calling the application service configured to meet business logic at an application level.

4. The method of claim 1, wherein calling the application service comprises calling the application service configured to support at least two different computing platforms.

5. The method of claim 1, wherein calling the enterprise service from the application service in response to the received first data, the enterprise service configured to retrieve the second data from the back-end system further comprises the enterprise service configured to retrieve the second data from the back-end system over an enterprise service bus comprising a middleware infrastructure.

6. The method of claim 1, wherein calling the enterprise service from the application service further comprises calling the enterprise service configured to adhere to an interoperability standard comprising simple object access protocol (SOAP) plus header elements.

7. The method of claim 1, further comprising:
transmitting the second data from the enterprise service to the application service; and
providing a user with the second data.

8. A system for providing a structured application, the system comprising:
a memory storage for maintaining a database; and
a processing unit coupled to the memory storage, wherein the processing unit is operative to:
call an application service in response to a received request;
receive first data through the application service; and
call an enterprise service from the application service in response to the received first data, the enterprise service configured to retrieve second data from a back-end system.

9. The system of claim 8, wherein the processing unit being operative to call the application service comprises the processing unit being operative to call the application service comprising a presentation service configured to provide a user interface.

10. The system of claim 8, wherein the processing unit being operative to call the application service comprises the processing unit being operative to call the application service configured to meet business logic at an application level.

11. The system of claim 8, wherein the processing unit being operative to call the application service comprises the processing unit being operative to call the application service configured to support at least two different computing platforms.

12. The system of claim 8, wherein the processing unit being operative to call the enterprise service from the application service in response to the received first data, the enterprise service configured to retrieve the second data from the back-end system further comprises the enterprise service configured to retrieve the second data from the back-end system over an enterprise service bus comprising a middleware infrastructure.

13. The system of claim 8, wherein the processing unit being operative to call the enterprise service from the application service comprises the processing unit being operative to call the enterprise service configured to adhere to an interoperability standard comprising simple object access protocol (SOAP) plus header elements.

14. A computer-readable medium which stores a set of instructions which when executed performs a method for providing a structured application, the method executed by the set of instructions comprising:
calling an application service in response to a received request;
receiving first data through the application service; and
calling an enterprise service from the application service in response to the received first data, the enterprise service configured to retrieve second data from a back-end system.

15. The computer-readable medium of claim 14, wherein calling the application service comprises calling the application service comprising a presentation service configured to provide a user interface.

16. The computer-readable medium of claim 14, wherein calling the application service comprises calling the application service configured to meet business logic at an application level.

17. The computer-readable medium of claim 14, wherein calling the application service comprises calling the application service configured to support at least two different computing platforms.

18. The computer-readable medium of claim 14, wherein calling the enterprise service from the application service in response to the received first data, the enterprise service configured to retrieve the second data from the back-end system further comprises the enterprise service configured to retrieve the second data from the back-end system over an enterprise service bus comprising a middleware infrastructure.

19. The computer-readable medium of claim 14, wherein calling the enterprise service from the application service further comprises calling the enterprise service configured to adhere to an interoperability standard comprising simple object access protocol (SOAP) plus header elements.

20. The computer-readable medium of claim 14, further comprising:
transmitting the second data from the enterprise service to the application service; and
providing a user with the second data.
